(19) United States
(12) Patent Application Publication
(10) Pub. No.: US 2017/0109508 A1
(43) Pub. Date: Apr. 20, 2017

(54) INFORMATION PROCESSING APPARATUS, INFORMATION PROCESSING SYSTEM, AND AUTHENTICATION METHOD

(71) Applicant: Kazuharu SEMOTO, Tokyo (JP)

(72) Inventor: Kazuharu SEMOTO, Tokyo (JP)

(73) Assignee: Ricoh Company, Ltd., Tokyo (JP)

(21) Appl. No.: 15/288,194

(22) Filed: Oct. 7, 2016

(30) Foreign Application Priority Data
Oct. 20, 2015 (JP) 2015-206282

(51) Int. Cl. G06F 21/31; H04L 12/06; H04L 29/06

(52) U.S. Cl. CPC G06F 21/31; H04L 63/083; H04L 12/06

(57) ABSTRACT

An information processing apparatus includes a plurality of interfaces each capable of receiving identification information identifying a user and input authentication information being a character string that is input by the user and circuitry that identifies one of the plurality of interfaces that has been used by the user to input the identification information and the input authentication information, as a used interface, selects, from among a plurality of items of authentication information for verification respectively provided for the plurality of interfaces, authentication information for verification that is provided for the used interface and corresponds to the identification information of the user, and authenticates the user based on a match between the input authentication information and the acquired authentication information for verification.

### CROSS-REFERENCE TO RELATED APPLICATION

This patent application is based on and claims priority pursuant to 35 U.S.C. §119(a) to Japanese Patent Application No. 2015-206282, filed on Oct. 20, 2015 in the Japan Patent Office, the entire disclosure of which is hereby incorporated by reference herein.

### BACKGROUND

Technical Field

The present invention relates to an information processing apparatus, an information processing system, and an authentication method.

Background Art in the information security field, a technology is known in which a user is authenticated using user identification information identifying the user and authentication information such as a password. In the known technology, authentication is performed assuming that the password is information that only the user who sets the password knows. For this reasons, in handling passwords, it is required to manage the passwords in a confidential manner using information that is hardly predictable. In addition, to cope with a brute force attack, complexity and length of the password should meet a sufficient level.

In information processing apparatuses such as multifunction peripherals (MFPs), multiple authentication routes are available in some cases, such as an authentication route via a control panel included in the information processing apparatus and an authentication route via a network from a screen on a client terminal. In the known technologies, a uniform password policy is applied regardless of authentication route.

If complex passwords are demanded regardless of authentication route without considering characteristics of each of the authentication routes, an excess burden is given to users in some cases from the viewpoint of operability and security. For example, for the authentication route via the control panel, if the brute force attack is tried, only attack in low speed can be performed compared to the authentication route via the network since manual user operation is required for the attack. That is, for the brute force attack via the control panel, it is excessive to apply the strict password policy just like the authentication route via the network, thus, burdening excessive labor on users.

### SUMMARY

Example embodiments of the present invention provide a novel information processing apparatus that includes a plurality of interfaces each capable of receiving identification information identifying a user and input authentication information being a character string that is input by the user and circuitry that identifies one of the plurality of interfaces that has been used by the user to input the identification information and the input authentication information, as a used interface, selects, from among a plurality of items of authentication information for verification respectively provided for the plurality of interfaces, authentication information for verification that is provided for the used interface and corresponds to the identification information of the user, and authenticates the user based on a match between the input authentication information and the acquired authentication information for verification.

Further example embodiments of the present invention provide an information processing system and an authentication method.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating a network environment including a MFP as an embodiment of the present invention;

FIG. 2 is a diagram illustrating functional blocks of the MFP of FIG. 1 as an embodiment of the present invention;

FIGS. 3A and 3B are diagrams illustrating login screens used for multiple input interfaces provided by the MFP of FIG. 1 as an embodiment of the present invention;

FIG. 4 is a diagram illustrating functional blocks related to an identification authentication operation compatible with multiple authentication routes implemented on the MFP as an embodiment of the present invention;

FIGS. 5A, 5B, and 5C are diagrams illustrating data structures of information managed by the MFP as an embodiment of the present invention;

FIG. 6 is a flowchart illustrating an identification authentication operation performed by the MFP as an embodiment of the present invention;

FIG. 7 is a flowchart illustrating an identification authentication operation performed by the MFP as an embodiment of the present invention;

FIG. 8 is a flowchart illustrating an identification authentication operation performed by the MFP as an embodiment of the present invention, and

FIG. 9 is a diagram illustrating a hardware configuration of the MFP as an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

A more complete appreciation of the disclosure and many of the attendant advantages thereof will be readily obtained as the same becomes better understood by reference to the following detailed description when considered in conjunction with the accompanying drawings.

Embodiments of the present invention are described below in detail with reference to figures. In figures, same symbols are assigned to same or corresponding parts, and their descriptions are simplified or omitted appropriately.

In the embodiments described below, a MFP 110 is described as an example of an information processing apparatus.

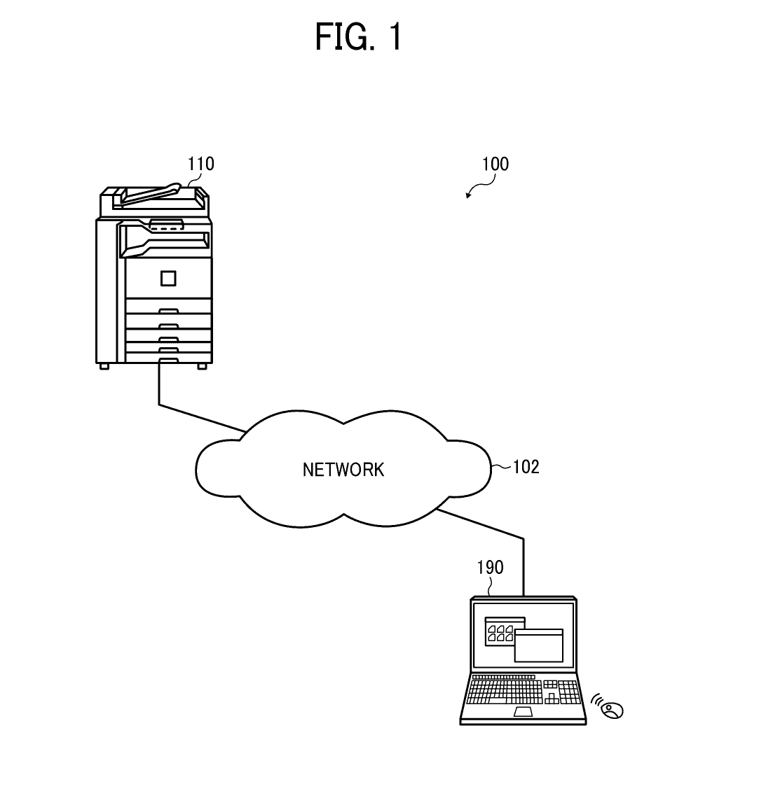

FIG. 1 is a diagram illustrating a network environment 100 including the MFP 110 in this embodiment In the network environment 100 in FIG. 1, the MFP 110 and a client terminal 190 connected with each other via a network 102 are illustrated. The MFP 110 and the client terminal 190 are connected with each other to be communicable via the network 102. The network 102 may include a wired local area network, a wireless local area network, and a public network such as the Internet and a mobile communication network.

The MFP 110 is an apparatus that provides various image processing services such as print, scan, copy, and facsimile etc. to users. After the user is authenticated through authentication operation using authentication information, the user may use various functions provided by the MFP 110.

The client terminal 190 may access the MFP 110 via the network 102 to request the MFP 110 to print, scan, or transfer facsimile etc. In addition, the client terminal 190 may access the MFP 110 via the network 102 to remotely configure various settings.

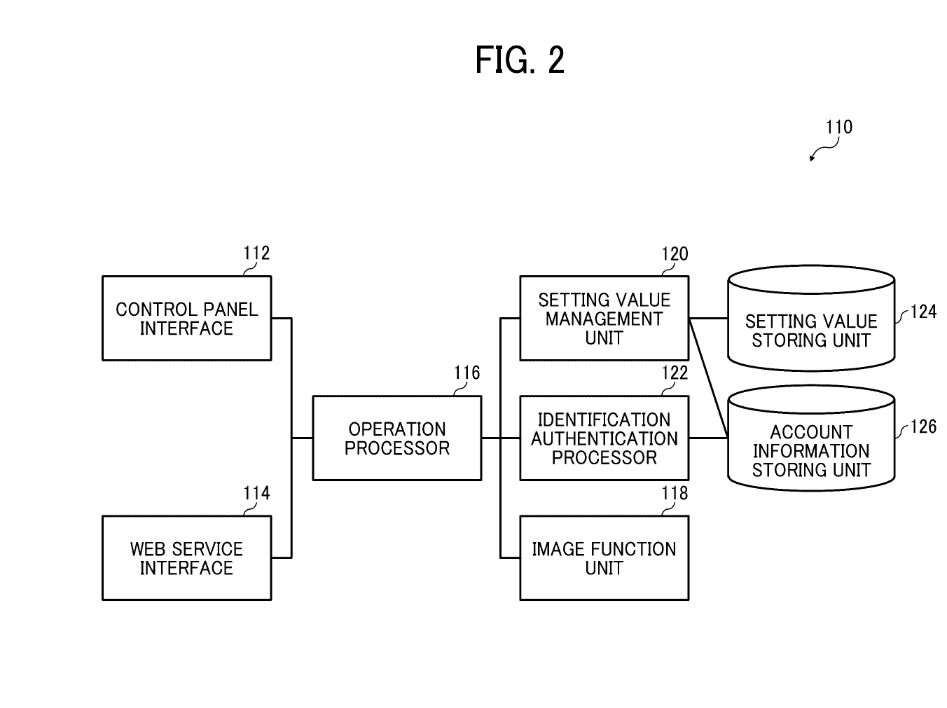

FIG. 2 is a diagram illustrating functional blocks of the MFP 110 in this embodiment. The MFP 110 in FIG. 2 includes a control panel interface 112, a web service interface 114, an operation processor 116, an image function unit 118, a setting value storing unit 120, an identification authentication processor 122, a setting value storing unit 124, and an account information storing unit 126.

The control panel interface 112 is implemented by, for example, a control panel included in the MFP 110 that is provided with either one of a hardware key and a software key such as a touch panel etc. or both of the hardware key and the software key. The control panel interface 112 accepts user operation that is input with the hardware key and the touch panel. After being accepted, the user operation is transferred to the operation processor 116, and the control panel interface 112 displays a result of the user operation under control of the operation processor 116. The control panel interface 112 requests the administrator to directly access the MFP 110 while being physically present at the MFP 110 to operate the MFP 110.

The web service interface 114 is an interface for accessing the MFP 110 via the network 102. The web service interface 114 includes a web server function and may accept user operation that is input with a web browser on the client terminal 190. After being accepted, the user operation is transferred to the operation processor 116, and the web service interface 114 displays a result of the user operation under control of the operation processor 116.

Hereinafter, the control panel interface 112 and the web service interface 114 may be collectively referred to as “interface”.

The operation processor 116 performs operation on data that is input from the input interfaces 112 and 114 and transfers the processed data to one or more of the functional units 118 to 122. In accordance with user operation performed on the interfaces 112 and 114, the operation processor 116 calls the image function unit 118, the setting value management unit 120, and the identification authentication processor 122.

The image function unit 118 provides various image functions implemented by the MFP 110 such as copy function, print function, scan function, and facsimile transfer function etc. The image function unit 118 accepts operations on various image functions from a user, and depending on a role and authority permitted to the user, the image function unit 122 performs the operation if the requested operation is allowed.

The setting value management unit 120 manages various setting items to control operations of the MFP 110. The setting value storing unit 124 stores setting values for various setting items to control operations of the MFP 110. The account information storing unit 126 stores account information for each user who uses the MFP 110.

The setting value management unit 120 accepts user operation on t setting items via the interfaces 112 and 114, and if the requested user operation may be allowed depending on a role and authority permitted to the user, the setting value management unit 120 reflects the user operation on the setting value stored in the setting value storing unit 124. Similarly, the setting value management unit 120 accepts operations of registering an account, modifying an account, and deleting an account via the interfaces 112 and 114. Depending on a role and authority permitted to the user, the setting value management unit 120 performs operations of registering an account, modifying an existing account, and deleting an existing account if the requested operation is allowed. In the description below, it is assumed that users have already been registered in the MFP 110 in an appropriate manner.

The identification authentication processor 122 identifies and authenticates users of the MFP 110. Based on account information registered in the account information storing unit 126 and input identification information and authentication information of the user, the identification authentication processor 122 identifies and authenticates the user to allow or reject the user's login. In case of allowing login, the identification authentication processor 122 may specify a role or authority permitted to the user.

In this embodiment, to perform the identification authentication operation, the web service interface 114 provides an authentication route based on communication to remote users using the external client terminal 190 etc. connected via the network 102. The control panel interface 112 provides an authentication route via the control panel that accepts physical operations to local users of the MFP 110. As a result, in this embodiment, the MFP 110 includes multiple authentication routes, and users can request the MFP 110 to authenticate the user using either one of the control panel interface 112 and the web service interface 114.

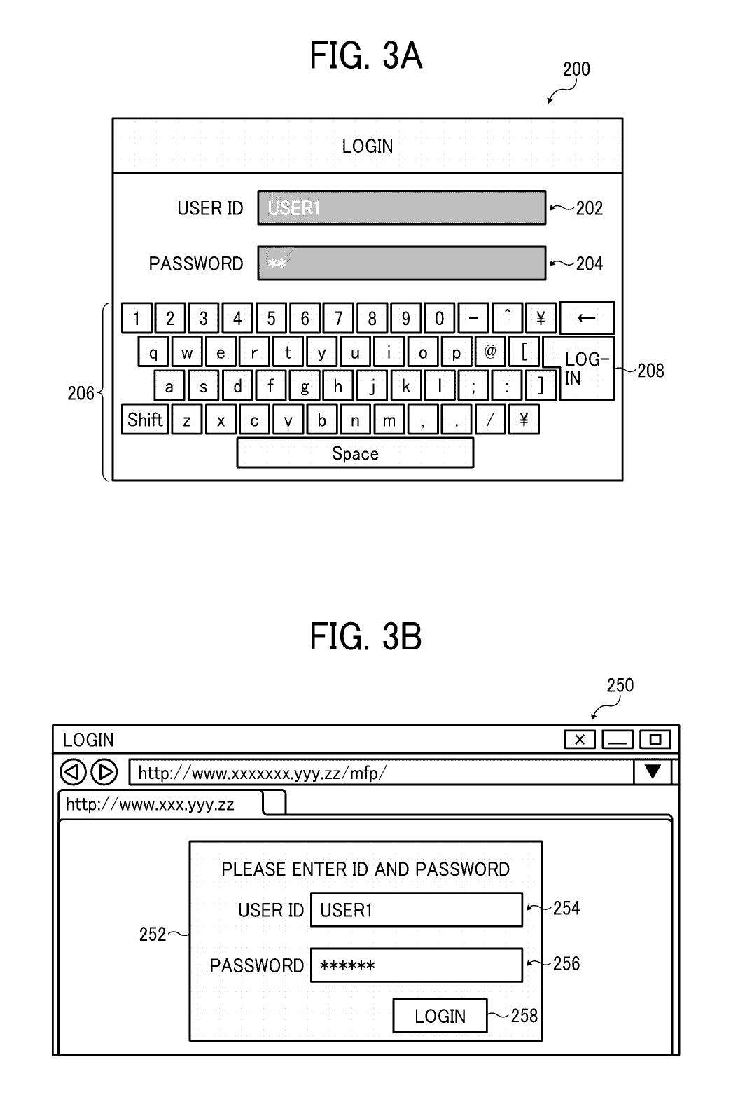

FIGS. 3A and 3B are diagrams illustrating login screens used for multiple input interfaces provided by the MFP 110 in this embodiment. FIG. 3A is a diagram illustrating an authentication screen 200 provided by the control panel interface 112, and FIG. 3B is a diagram illustrating an authentication screen 250 displayed on a display of the client terminal 190 provided by the web service interface 114.

Each of the authentication screens 200 and 252 includes graphical user interface (GUI) parts 202 and 254 each for inputting the user's identification information and GUI parts 204 and 256 each for inputting authentication information such as the password etc., and buttons 208 and 258 each for accepting a command to request for authentication. The authentication screen 200 displayed on the display of the control panel illustrated in FIG. 3A further includes a software keyboard 206.

In the identification authentication operation described above, the authentication operation in combination with the user's identification information and authentication information is performed by identifying the user using the user's identification information and authenticates the user using the authentication information such as the password etc. That is, the user is authenticated based on the authentication information, which is a string (i.e., the password) that is known to only the user who configured the authentication information. For this reason, it is required to manage the passwords in a confidential manner, as well as configuring the password in a manner that is hardly predictable. In principle, it is possible that the authentication method using the password is broken through using the brute force attack trying any combination of characters, and a tool that tries the brute force attack via a network exists. To cope with this issue, the password policy gets stringent such as requesting the password to be a mix of alphabets, numeric characters, and symbols, with a length equal to or more than a predetermined length. This may increase a number of attacks required to succeed the brute force attack and prevent the password from being broken.

However, if the password policy becomes stringent, user operability tends to reduce, since the user needs to memorize the password that is more complex, or the user needs to input the password that is more complex through the interface 112 or 114. For example, it is difficult to allocate a sufficiently large area for the control panel in some cases, incurring user burden in operation. Especially, in case of adopting a software keyboard 206 illustrated in FIG. 3A, operability burden becomes heavier compared to a hardware keyboard from the viewpoint of assuredness of operation, response of operation, and feedback characteristic of input etc. That is, operation burden of the control panel interface 112 is heavier than the web service interface 114. As a result, if the stringent password policy common to the authentication route via the network is applied, the user burden may be excessive.

From the viewpoint of increasing the security strength, it is possible to try vast amounts of attack trials through the authentication route via a network. Therefore, it is appropriate to apply a stringent password policy. However, for the authentication route via the control panel, manual user operation is required. This makes it difficult to perform a sequence of attacks due to responsiveness and tiredness due to repeating of such manual operations. As a result, attacks through this authentication route via the control panel is overwhelmingly slower compared to the authentication route via the network, in addition, for the authentication route via the control panel, the user is required to physically access the MFP 110, such that the security is relatively high, That is, for the brute force attack via the control panel, it is excessive to apply the strict password policy just like the authentication route via the network, which results in excessive user burden.

If the common uniform password policy is applied for all authentication routes which may differ in characteristics, the user burden becomes too excessive from the viewpoint of operability and security strength, Integrated Circuit (IC) cards and biometric authentication are also known as simpler authentication methods. However, it is required to prepare dedicated hardware such as an IC card reader, a biometric information scanner, and a server for managing authentication information, and it is difficult to implement those methods from the viewpoint of cost and management.

To cope with this issue, the MFP 110 in this embodiment accepts input identification information and input authentication information based on a string, which are input via any one of the multiple authentication routes, and acquires authentication information for verification that corresponds to the input identification information based on the authentication route that is used for input (“used authentication route”) among the multiple authentication routes. Subsequently, the MFP 110 determines that authentication succeeds if the input authentication information based on the string corresponds to the acquired authentication information for verification that is obtained in accordance with the used authentication route.

As described above, by using different authentication information that should be input by user operation for each authentication route, it is possible to apply an appropriate policy in accordance with characteristics of authentication routes. As a result, by alleviating policies for interfaces whose security threat is not big and operation burden is heavy, it is possible to maintain sufficient security and ease the operation burden. Consequently, instead of preparing additional hardware, in accordance with the characteristic of the used route among multiple authentication routes, it is possible to adjust security strength of authentication information and operation burden for inputting the authentication information.

In this embodiment, the MFP 110 is described as an example of the information processing apparatus. However, the information processing apparatus is not limited to the MFP 110 described in this embodiment. For example, whatever information processing apparatuses requiring predetermined authentication and including multiple authentication routes such as an image forming apparatus such as a laser printer, an image scanning apparatus such as a scanner, an image communication apparatus such as a facsimile machine, an image projecting apparatus such as a projector, an image displaying apparatus, a server apparatus, an remote conference terminal, an electronic whiteboard, a portable information terminal, an image capturing apparatus, a vending machine, a medical equipment, a power supply apparatus, an air-conditioning system, a measuring apparatus such as gas, water, and electricity, and a network home appliance such as a refrigerator and a washing machine may be adopted.

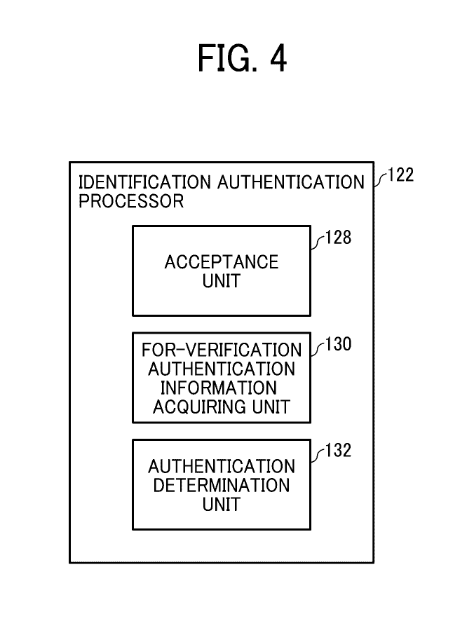

FIG. 4 is a diagram illustrating functional blocks of the MFP 10, related to an identification authentication operation via multiple authentication routes in this embodiment. As illustrated in FIG. 4, more specifically, the identification authentication processor 122 includes an acceptance unit 128, a for-verification authentication information acquisition unit 130, and an authentication determination unit (determining unit) 132.

The acceptance unit 128 accepts identification information and authentication information input via either one of the interfaces 112 and 114 as the multiple authentication routes hereinafter, the authentication information input by user operation is referred to as input authentication information). In this embodiment, the authentication route includes two authentication routes provided by the control panel interface 112 and the web service interface 114, respectively. The acceptance unit 128 also accepts information indicating a type of the used interface (i.e., either the control panel or the web service) from the interfaces 112 and 114 that the identification information and the authentication information are input via the operation processor 116.

Based on the used authentication route among the interfaces 112 and 114 as the multiple authentication routes, the for-verification authentication information acquisition unit 130 acquires authentication information for verification in accordance with the used authentication route, which corresponds to the identification information (hereinafter, the authentication information for verification for collating with the input authentication information input by user operation is referred to as the authentication information for verification).

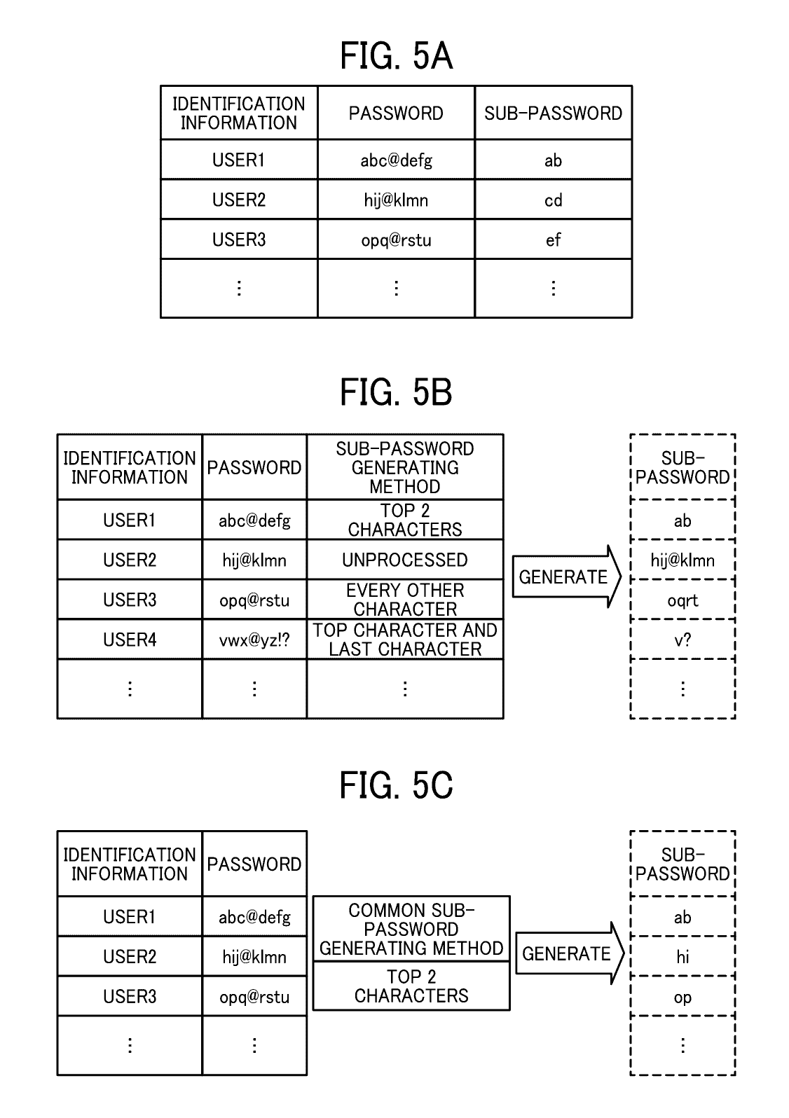

FIG. 5A is a diagram illustrating a data structure of account information managed on the account information storing unit 126 in the MFP 110 in this embodiment. As illustrated in FIG. 5A, the account information further includes a sub-password in addition to user identification information and a password.

Here, the password and sub-password are each authentication information expressed in a character string including at least any one of alphabets, numerals, “Kana” characters, symbols, and double-byte characters, and requires a sequence of user input operations for each character. In some cases, password policies such as requirements for complexity (e.g., it is required to use alphabetical characters, numeric characters, and symbolic characters or mix uppercase characters with lowercase characters etc.) and requirements for password length (e.g., equal to or longer than eight characters etc.) are applied. However, that is not particularly limited in this case. In FIG. 5A, independent password policies are permitted to each of the multiple authentication routes, and as illustrated in FIG. 5A, sub-passwords shorter than the passwords in length are allowed.

In this embodiment, the for-verification authentication information acquisition unit 130 refers to the account information illustrated in FIG. 5A to acquire the authentication information for verification (the password or the sub-password) corresponding to the input identification information, provided for the used authentication route, which is selected from among the authentication information for verification (the password and the sub-password) used by the interfaces 112 and 114 as the multiple authentication routes.

The authentication determination unit 132 determines that the authentication succeeds if the input authentication information corresponds to the authentication information for verification corresponding to the used authentication route. The authentication determination unit 132 determines that the authentication fails if there is no account information corresponding to the identification information or the input authentication information does not correspond to the acquired authentication information for verification.

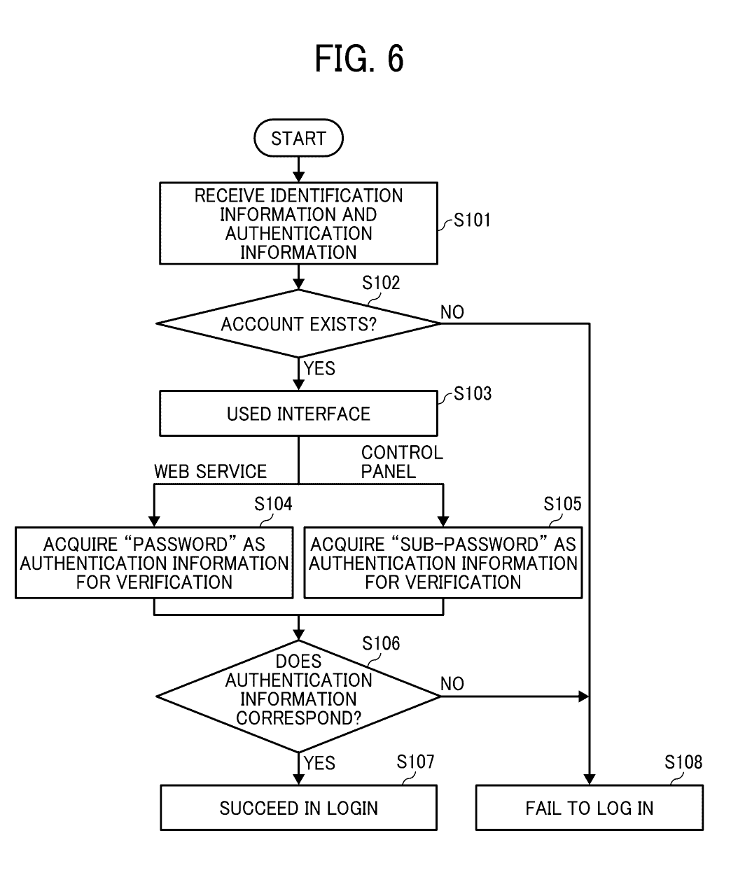

An identification authentication operation in this embodiment is described below in detail with reference to FIG. 6. FIG. 6 is a flowchart illustrating an identification authentication operation performed by the MFP 110 in this embodiment.

The operation illustrated in FIG. 6 starts in response to a request for authentication by user operation. The MFP 110 receives user operation, which inputs the identification information and the authentication information corresponding to the user account via any one of the interfaces 112 and 114 using the authentication screen 200 or 252 illustrated in FIGS. 3A and 3B. Subsequently, the request for authentication is performed in response to detecting that the button 208 or 258 commanding login is pressed.

In S101, the MFP 110 receives the identification information and the input authentication information input via either one of the interfaces 112 and 114 as the multiple authentication routes. The one of the interfaces 112 and 114, which is used for input, adds its own type (i.e., control panel of web service interface as type information identifying the used interface (that is, own interface to the input identification information and the input authentication information, and transfers the information including the type information and the input information to the operation processor 116.

In S102, the MFP 110 determines whether or not an account corresponding to the input identification information exists. More specifically, the operation processor 116 transfers the input identification information to the identification authentication processor 122 to inquire whether or not the corresponding account information exists. After the acceptance unit 128 receives the sent identification information, the identification authentication processor 122 searches for account information corresponding to the transferred identification information through multiple account information registered in the account information storing unit 126. If an account that matches the transferred identification information does not exist, the identification authentication processor 122 responds with a message indicating that the appropriate account does not exist due to a failure of the input identification information. If the account that matches the transferred identification information exists, the identification authentication processor 122 responds with a message indicating that the account for the input identification information exists.

In S102, if it is determined that the corresponding account exists (YES in S102), the operation proceeds to S103. In S103, the MFP 110 branches the operation in accordance with the used interface. The acceptance unit 128 in the identification authentication processor 122 accepts the authentication information and information on used interface (i.e., control panel or web service) transferred by the operation processor 116. The identification authentication processor 122 branches the operation depending on the information on used interface.

In S104 and S105, based on the interface of the used authentication route among multiple authentication routes, the authentication information for verification in accordance with the used authentication route corresponding to the identification information is acquired. More specifically, if the used interface is the web service interface 114 (web service in S103), the operation proceeds to S104. In S104, the MFP 110 acquires a “password” in the account information as the authentication information for verification, and the operation proceeds to S106. By contrast, if the used interface is the control panel interface 112 (control panel in S103), the operation proceeds to S105. In S105, the MFP 110 acquires a “sub-password” in the account information as the authentication information for verification, and the operation proceeds to S106.

In S106, the MFP 110 determines whether or not the input authentication information corresponds to the authentication information for verification acquired in S104 or S105. If it is determined that the input authentication information corresponds to the authentication information for verification (YES in S106), the operation proceeds to S107, and the MFP 110 determines that the authentication succeeds (i.e., login succeeds). By contrast, if it is determined that the input authentication information does not correspond to the authentication information for verification (NO in S106), the operation proceeds to S108, and the MFP 110 determines that the authentication fails (i.e., login fails). By contrast, if it is determined that the account does not exist (NO in S102), the operation also proceeds to S108, and the MFP 110 determines that the authentication fails (i.e., login fails).

In this embodiment, as illustrated in FIG. 5A, “password” and “sub-password” can be configured as the account information separately. As illustrated in FIG. 5A, in an account whose user identifier is “USER1”, “abc@defg” is registered as the password, and “ab” is registered as the sub-password. Subsequently, in accordance with the flowchart illustrated in FIG. 6, in case of the authentication operation via the web service interface 114, login is allowed only if the input password corresponds to the password “abc@def”. By contrast, in case of the authentication operation via the control panel interface 112, login is allowed only if the input password corresponds to the sub-password “ab”. In this embodiment, the password and the sub-password are stored in a format of a string. However, the password and the sub-password may be stored in a format of a hash value in other embodiments.

As a result, for the authentication route via the web service interface 114 that may be vulnerable, the administrator may request for a complicated and long password resistant to the brute force attack to ensure sufficient security strength. By contrast, for the authentication route via the control panel interface 112 that only accepts manual user operation and hardly accepts repeated trial attacks, the administrator may alleviate the security policy to use the password such as “ab” that satisfies both the security strength suitable for the interface and higher user operability.

In FIG. 5A, the sub-password whose length is two characters is registered. However, the password policy for the sub-password is not limited. By configuring the sub-password just like the password, the user may use the same password regardless of the interfaces. Otherwise, by setting a blank to the sub-password, it is possible to log in the MFP 110 via the control panel without authentication. In other cases, by registering the sub-password whose length is four characters, it is possible to ensure the security strength a bit more.

Regarding the authentication method described above, some mechanisms in existing security are provided. It is possible to operate the sub-password likewise. For example, a so-called account lock function that prohibits to use the account in case of inputting wrong passwords for a certain amount of time is known. Similarly, the account lock function may be applied in case of failing in inputting a correct sub-password. It is possible to count the number of times the wrong passwords are input and the number of times the wrong sub-passwords are input separately to lock the account separately. In other cases, it is possible to count the total number of times the wrong passwords are input and wrong sub-passwords to lock the account separately. Otherwise, it is possible to count the total number of times of inputting wrong passwords and wrong sub-passwords conjunctively. A password policy that requests for a certain amount of strength in registering passwords is also known. It is possible to apply the password policy to the sub-password. In that case, it is preferable that policy may be applied for each authentication route separately.

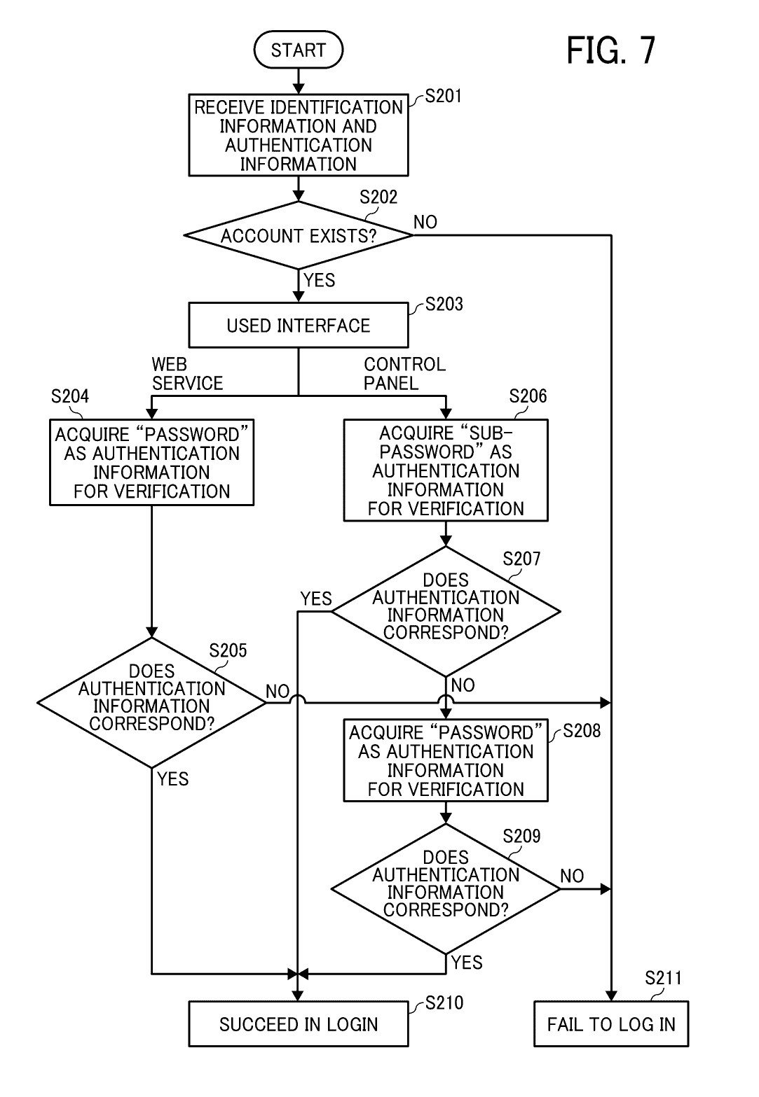

An identification authentication operation performed by the MFP 110 in other embodiments is described below with reference to FIG. 7. It should be noted that the same configuration as the embodiment described before with reference to FIGS. 1 to 6 is implemented in the other embodiments illustrated in FIG. 7. Therefore, difference points between those embodiments are mainly described below. Similarly, the operation illustrated in FIG. 7 starts in response to a request for authentication by user operation.

In S201, the MFP 110 accepts the identification information and the input authentication information input via either one of the interfaces 112 and 114 as the multiple authentication routes. In S202, the MFP 110 determines whether or not an account corresponding to the input identification information exists. In S202, if it is determined that the corresponding account exists (YES in S102), the operation proceeds to S203. In S203, the MFP 110 branches the operation in accordance with the used interface.

If the used interface is the web service interface 114 (web service in S203), the operation proceeds to S204. In S204, the MFP 110 acquires “password” in the account information corresponding to the input identification information as the authentication information for verification, and the operation proceeds to S205. In S205, the MFP 110 determines whether or not the input authentication information corresponds to the authentication information for verification acquired in S204. If it is determined that the input authentication information corresponds to the authentication information for verification (YES in S205), the operation proceeds to S210, and the MFP 110 determines that the authentication succeeds (i.e., login succeeds). By contrast, if it is determined that the input authentication information does not correspond to the authentication information for verification (NO in S205), the operation proceeds to S211, and the MFP 110 determines that the authentication fails (i.e., login fails).

By contrast, if the used interface is the control panel interface 112 (control panel in S203), the operation proceeds to S206. In S206, the MFP 110 acquires “sub-password” in the account information corresponding to the input identification information as the authentication information for verification, and the operation proceeds to S207. In S207, the MFP 110 determines whether or not the input authentication information corresponds to the authentication information for verification acquired in S206. If it is determined that the input authentication information corresponds to the authentication information for verification (YES in S207), the operation proceeds to S210, and the MFP 110 determines that the authentication succeeds (i.e., login succeeds).

By contrast, if it is determined that the input authentication information does not correspond to the authentication information for verification (NO in S207), the operation further proceeds to S208. In S208, in order to determine authentication additionally, the MFP 110 acquires a “password” in the account information corresponding to the input identification information as the authentication information for verification, and the operation proceeds to S209. In S209, the MFP 110 determines whether or not the input authentication information corresponds to the authentication information for verification acquired in S208. If it is determined that the input authentication information corresponds to the authentication information for verification (YES in S209), the operation proceeds to S210, and the MFP 110 determines that the authentication succeeds (i.e., login succeeds). By contrast, if it is determined that the input authentication information does not correspond to the authentication information for verification (NO in S209), the operation proceeds to S211, and the MFP 110 determines that the authentication fails (i.e., login fails).

In the identification authentication operation illustrated in FIG. 6, it is determined that the login fails immediately if the input authentication information does not correspond to the authentication information for verification. By contrast, in the identification authentication operation illustrated in FIG. 7, even if the input authentication information does not correspond to the authentication information for verification (e.g., sub-password) corresponding to the used interface, it is possible to proceed to the further authentication operation. That is, if there is an authentication route (e.g., the web service) whose input burden is lighter than the used authentication route (e.g., the control panel) and thus expected that more stringent password policy is applied, an authentication information (e.g., the password) in accordance with the authentication route (e.g., the web service) is acquired. Subsequently, if the input authentication information corresponds to the further acquired authentication information for verification, it is determined that the authentication succeeds.

In the MFP 110 in this embodiment, user operation burden for inputting the password is heavy regarding the authentication route via the control panel interface 112. Therefore, the MFP 110 can allow loose passwords. As a result, considering a purpose of authentication, if a user knows a more complicated password used in the authentication route via the web service interface 114, it is appropriate to authenticate the user who inputs the complicated password even via the control panel 112. Therefore, in the embodiment illustrated in FIG. 7, even if it is determined that the input authentication information does not correspond to the authentication information for verification (NO in S207), it is determined whether or not the input authentication information corresponds to the other authentication information for verification again in S208 and S209. Subsequently, if it is determined that the input authentication information corresponds to the other authentication information for verification, it is determined that the authentication succeeds.

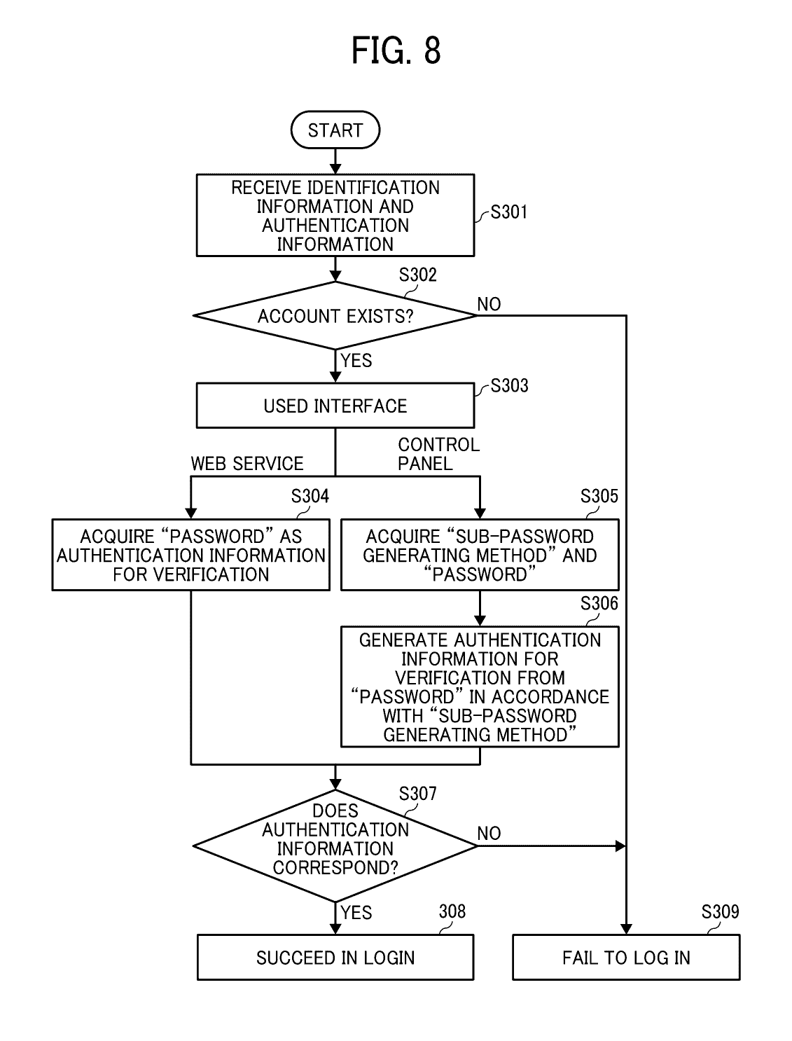

An identification authentication operation performed by the MFP in other embodiments is described below with reference to a data structure in FIG. 5B and a flowchart in FIG. 8. FIG. 5A is a diagram illustrating a data structure of account information managed on the account information storing unit 126 in the MFP 110 in this embodiment. In FIG. 5B, data indicated by solid lines indicates information managed in the account information management unit 126 actually, and data indicated by dash lines indicates information generated based on the actually managed information.

It should be noted that the same configuration as the embodiment described before with reference to FIGS. 1 to 6 is implemented in the other embodiments illustrated in FIGS. 5B and 8. Therefore, difference points between those embodiments are mainly described below. Similarly, the operation illustrated in FIG. 8 starts in response to a request for authentication by user operation.

In S301, the MFP 110 accepts the identification information and the input authentication information input via either one of the interfaces 112 and 114 as the multiple authentication routes, In S302, the MFP 110 determines whether or not an account corresponding to the input identification information exists. In S302, if it is determined that the corresponding account exists (YES in S302), the operation proceeds to S303. In S303, the MFP 110 branches the operation in accordance with the used interface.

If the used interface is the web service interface 114 (web service in S303), the operation proceeds to S304. In S304, the MFP 110 acquires “password” in the account information as the authentication information for verification, and the operation proceeds to S307.

By contrast, if the used interface is the control panel interface 112 (control panel in S303), the operation proceeds to S305. S305, the MFP 110 acquires “sub-password generating method” and “password” in the account information corresponding to the input identification information. In S306, based on the acquired password, the MFP 110 generates the authentication information for verification along with a rule specified by the sub-password generating method, and the operation proceeds to S307.

With reference to FIG. 5B, in the account information for each user, there is “sub-password generating method” in addition to “identification information” and “password”, and rules such as “top 2 characters”, “unprocessed”, “every other character”, and “top character and last character” are registered. The generating method “top 2 characters” is registered for the identification information “USER1”. Therefore, by using only two top characters in the password are used to generate the sub-password “ab” as indicated by dash lines. The generating method “unprocessed” is registered for the identification information “USER2”. Therefore, the sub-password “hij@klmn” just like the password is generated as indicated by dash lines. The generating method “every other character” is registered for the identification information “USER3”. Therefore, every other characters are extracted from the password to generate the sub-password “oqrt” as indicated by dash lines. The generating method “top character and last character” is registered for the identification information “USER4”. Therefore, by adding the top character, to the last character, the sub-password “v?” is generated as indicated by dash lines.

In S307, the MFP 110 determines whether or not the input authentication information corresponds to the authentication information for verification acquired in S304 or S306. If it is determined that the input authentication. information. corresponds to the authentication information for verification (YES in S307), the operation proceeds to S308, and the MFP 110 determines that the authentication succeeds (i.e., login succeeds). By contrast, if it is determined that the input authentication information does not correspond to the authentication information for verification (NO in S307), the operation proceeds to S309, and the MFP 110 determines that the authentication fails (i.e., login fails).

In the embodiment illustrated in FIGS. 5B and 8, just like the embodiment illustrated in FIGS. 5A and 6, different passwords may be used in accordance with the used interface, On the other hand, in the embodiment illustrated in FIGS. 5B and 8, a password generated based on the authentication information for verification (e.g., password) used in one authentication route (e.g., the web service) corresponding to the identification information in accordance with the predetermined. rule (e,., top 2 characters is acquired as the authentication information for verification (e.g., sub-password) used in the other authentication route (e.g., the control panel). Accordingly, the predetermined rules correspond to each of the multiple identification information.

The predetermined rules described above may include a rule that the authentication information for verification corresponding to the identification information is used as is and a rule that predetermined sequential or non-sequential parts are extracted among the authentication information corresponding to the identification information. Here, examples of the predetermined sequential or non-sequential parts are a string from the top whose number of characters is predetermined, a string from the bottom whose number of characters is predetermined, a string combining a string from the top whose number of characters is predetermined with a string from the bottom whose number of characters is predetermined, and a string picked up from an original string in a predetermined interval of characters. As described above, the predetermined rule for generating the authentication information for verification as the information for acquiring the authentication information for verification.

In the embodiment illustrated in FIGS. 5A and 6, the password is completely different from the sub-password. Therefore, depending on the content to be registered, the user is required to memorize multiple passwords, However, in the embodiment illustrated in FIGS. 5B and 8, those passwords are partly in common. Therefore, it is required that the user memorizes only one password.

As described above, in this embodiment, there are multiple generating methods, and the generating methods may be selected for each user preliminarily. As a result, it is possible to provide multiple choices for each user from the viewpoint of easiness of memorization and security strength, and it is possible to provide convenience and security strength in accordance with use environment.

An embodiment different from the embodiment illustrated in FIGS. 5B and 8 is described below with reference to FIG. 5C. In the embodiment described above with reference to FIGS. 5B and 8, the generating method for generating the sub-password are configured for each of the identification information separately. By contrast, in the embodiment illustrated in FIG. 5C, the generating method for generating the sub-password is configured in common with multiple identification information. It is possible to configure the generating method for generating the sub-password described above in common with all users. Otherwise, it is possible to configure the generating method for generating the sub-password described above in common with a specific group or a specific role. The generating method is stored in not the account information storing unit 126 but the setting value storing unit 124 as a setting value. As described above, by fixing the generating method for generating the sub-password, the administrator may administrate the system easily,

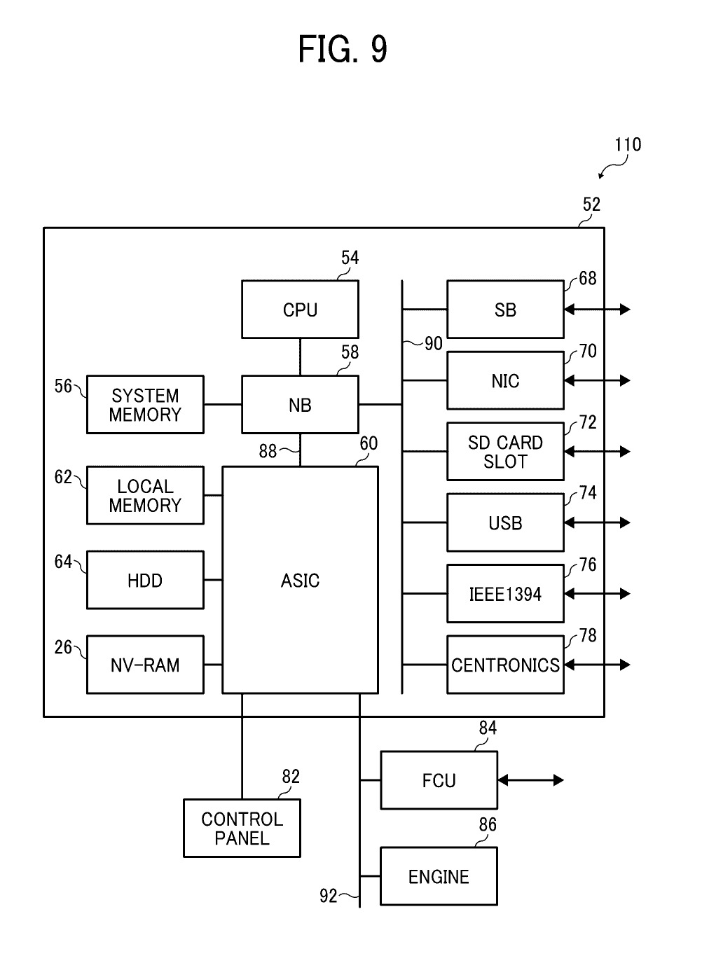

The hardware configuration of the MFP 110 is described below with reference to FIG. 9. FIG. 9 is a diagram illustrating a hardware configuration of the MFP in this embodiment. The MFP 110 includes a controller 52, a control panel 82, a facsimile control unit (FCU) 84, and an engine 86. The controller 52 includes a CPU 54, a Northbridge (NB) 58, an ASIC 60 connected to the CPU 54 via the NB 58, and a system memory 56. The ASIC 60 processes various images, and the ASIC 60 is connected to the NB 58 via an Accelerated Graphic Port (AGP) 88. The system memory 56 is used as a memory for drawing images etc.

The ASIC 60 is connected to a local memory 62, a hard disk drive (HDD) 64, and a nonvolatile memory (e.g., a flash memory etc.) 66 (hereinafter referred to as “NVRAM 66”). The local memory 62 is used as an image buffer for copying and a code buffer, and the HIM) 64 is a storage device that stores image data, document data, programs, font data, and form data etc. The NVRAM 66 stores programs for controlling the MFP 110, various system information, and various setting information.

The controller 52 further includes a Southbridge (SB) 68, a network interface card (NIC) 70, a Secure Digital (SD) card slot 72, a USB interface 74, an IEEE 1394 interface 76, and a Centronics interface 78, and those components are connected to the NB 58 via a PCI bus 90. The SB 68 is a bridge that connects a ROM and PCI bus peripheral devices etc. to the NB 58. The NIC 70 is an interface that connects the MFP 110 to the network 102 such as the Internet and a LAN etc., and the NIC 70 accepts commands and requests via the network, The NIC 70 constructs the web service interface 114 illustrated in FIG. 2. The SD card slot 72 mounts a SD card detachably. The USB interface 74, the IEEE 1394 interface 76, and the Centronics interface 78 are interfaces compatible with each specification (standard) and accepts a print job etc.

The control panel 82 is connected to the ASIC 60 in the controller 52 to accept various input commands and requests by user operation and provide a user interface for displaying a screen. The control panel 82 constructs the control panel interface 112 illustrated in FIG. 2. The FCU 84 and the engine 86 are connected to the ASIC 60 via the PCI bus 92. The FCU 84 performs communication methods compatible with facsimile communication specifications (standards) such as G3 and G4 etc. After accepting a request for print and a request for scan issued by an application, the engine 86 performs an image forming process and an image scanning process. The engine 86 constructs the scanner and the printer.

The MFP 110 in this embodiment reads control programs from the HDD 64 and NVRAM 66 and expands the read control program into a work area provided by the system memory 56 and the local memory 62 to implement the functional units (functional components) and processes described above under control of the CPU 54. In the embodiments described above, all functional units are implemented on a single MFP 110. However, these functional units may be implemented using the MFP 110 and other computer apparatuses decentralizedly to construct an information processing system.

In the embodiments described above, the information processing apparatus that may adjust the security strength and operation burden on inputting the authentication information in accordance with the used authentication route among multiple authentication routes.

The present invention also encompasses a non-transitory recording medium storing a program that executes a method of authenticating a user operating an information processing apparatus. The authentication method includes the steps of providing a plurality of interfaces each capable of receiving identification information identifying a user and input authentication information being a character string that is input by the user, identifying one of the plurality of interfaces that has been used by the user to input the identification information and the input authentication information, as a used interface, selecting, from among a plurality of items of authentication information for verification respectively provided for the plurality of interfaces, authentication information for verification that is provided for the used interface and corresponds to the identification information of the user, and authenticating the user based on a match between the input authentication information and the acquired authentication information for verification.

In the above-described example embodiment, a computer can be used with a computer-readable program, described by object-oriented programming languages such as C++, Java (registered trademark), javaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination. The computer software can be provided to the programmable device using any storage medium or carrier medium for storing processor-readable code such as a floppy disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these.

In the embodiments described above, a novel image forming apparatus that may reduce a burden on the administrator and deterring users from transferring information to the other apparatus is provided.

Numerous additional modifications and variations are possible in light of the above teachings. It is therefore to be understood that within the scope of the appended claims, the disclosure of the present invention may be practiced otherwise than as specifically described herein.

For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information processing apparatus, comprising:
a plurality of interfaces each capable of receiving identification information identifying a user and input authentication information being a character string that is input by the user; and
circuitry to:
identify one of the plurality of interfaces that has been used by the user to input the identification information and the input authentication information, as a used interface;
select, from among a plurality of items of authentication information for verification respectively provided for the plurality of interfaces, authentication information for verification that is provided for the used interface and corresponds to the identification information of the user; and
authenticate the user based on a match between the input authentication information and the acquired authentication information for verification.

2. The information processing apparatus according to claim 1,
wherein the circuitry acquires the authentication information for verification that is associated with the used interface, from among the plurality of items of authentication information for verification respectively provided for the plurality of interfaces each corresponding to the identification information of the user.

3. The information processing apparatus according to claim 1,
wherein the plurality of interfaces includes a first interface and a second interface, and
the circuitry generates the authentication information for verification for the first interface according to a predetermined rule, and further generates the authentication information for verification for the second interface based on the authentication information for verification for the first interface.

4. The information processing apparatus according to claim 3,
wherein the predetermined rule is set differently for each one of a plurality of items of identification information each identifying a user.

5. The information processing apparatus according to claim 3,
wherein the predetermined rule is set common for a plurality of items of identification information each identifying a user.

6. The information processing apparatus according to claim 3,
wherein the predetermined rule indicates to use the authentication information for verification that is associated with the identification information of the user is used as is for the first interface, and
a sequential or non-sequential part in the authentication information for verification that is associated with the identification information of the user is extracted to be used for the second interface.

7. The information processing apparatus according to claim 1,
wherein the plurality of interfaces includes a first interface and a second interface, the first interface allowing the user to input information with less burden, and
wherein, when the determination indicates that the input authentication information that is input using the second interface does not match the authentication information for verification that is provided for the second interface,
the circuitry further acquires authentication information for verification that is provided for the first interface, and authenticates the user based on a match between the input authentication information and the acquired authentication information for verification for the first interface.

8. The information processing apparatus according to claim 2,
wherein the plurality of interfaces includes a first interface and a second interface, the first interface allowing the user to input information with less burden, and
wherein, when the determination indicates that the input authentication information that is input using the second interface does not match the authentication information for verification that is provided for the second interface,
the circuitry further acquires authentication information for verification that is provided for the first interface, and authenticates the user based on a match between the input authentication information and the acquired authentication information for verification for the first interface.

9. The information processing apparatus according to claim 3,
wherein the plurality of interfaces includes a first interface and a second interface, the first interface allowing the user to input information with less burden, and
wherein, when the determination indicates that the input authentication information that is input using the second interface does not match the authentication information for verification that is provided for the second interface,
the circuitry further acquires authentication information for verification that is provided for the first interface, and authenticates the user based on a match between the input authentication information and the acquired authentication information for verification for the first interface.

10. The information processing apparatus according to claim 1,
wherein the plurality of interfaces includes a first interface and a second interface, the first interface allowing the user to input information with less burden than a burden required by the first interface in inputting information.

11. The information processing apparatus according to claim 10,
wherein the first interface is a network interface that receives a user instruction through a communication network, and the second interface is a control panel that receives a user operation.

12. The information processing apparatus according to claim 1,
wherein multiple authentication routes respectively provided by the plurality of interfaces are applied with security policies that are different from one another.

13. The information processing apparatus according to claim 2,
wherein multiple authentication routes respectively provided by the plurality of interfaces are applied with security policies that are different from one another.

14. An information processing system, comprising:
a memory to store data for acquiring the authentication information for verification;
multiple interfaces to provide multiple authentication routes separately; and
circuitry to:
accept input authentication information based on identification information and a string input using any one of the multiple interfaces providing one of the multiple authentication routes;
store, in association with the identification information, the data for acquiring the authentication information for verification for each of the multiple authentication routes in the memory;
determine the authentication information to be used based on the used authentication route among the multiple authentication route; and
determine, if the input authentication information based on the input string corresponds to the determined authentication information for verification in accordance with the used authentication route, that authentication succeeds.

15. The information processing system according to claim 14,
wherein the data for acquiring the authentication information for each of the multiple authentication routes is a predetermined rule that specifies the authentication information for verification to be used or how to generate the authentication information for verification.

16. The information processing system according to claim 14,
wherein the circuitry acquires information generated along with a predetermined rule based on the authentication information used with one authentication route associated with the identification information as the authentication information for verification used with another authentication route.

17. A method of authenticating a user operating an information processing apparatus, the method comprising:
providing a plurality of interfaces each capable of receiving identification information identifying a user and input authentication information being a character string that is input by the user;
identifying one of the plurality of interfaces that has been used by the user to input the identification information and the input authentication information, as a used interface;
selecting, from among a plurality of items of authentication information for verification respectively provided for the plurality of interfaces, authentication information for verification that is provided for the used interface and corresponds to the identification information of the user; and
authenticating the user based on a match between the input authentication information and the acquired authentication information for verification.

18. The information processing method according to claim 17, the method further comprising:
acquiring the authentication information for verification that is associated with the used interface, from among the plurality of items of authentication information for verification respectively provided for the plurality of interfaces each corresponding to the identification information of the user.

19. The information processing method according to claim 17, the method further comprising:
generating the authentication information for verification for a first interface according to a predetermined rule, and further generates the authentication information for verification for a second interface based on the authentication information for verification for the first interface.
